(19) United States
(12) Patent Application Publication
(10) Pub. No.: US 2025/0365823 A1
(43) Pub. Date: Nov. 27, 2025

(54) POWER SUPPLY ASSEMBLY AND ELECTRONIC ATOMIZATION DEVICE AND CONTROL METHOD THEREOF

(71) Applicant: SHENZHEN FIRST UNION TECHNOLOGY CO., LTD., Shenzhen, Guangdong (CN)

(72) Inventors: Xinjun LI, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 18/873,154

(22) PCT Filed: Jun. 6, 2023
(86) PCT No.: PCT/CN2023/098511

§ 371 Date: Dec. 9, 2024

(30) Foreign Application Priority Data
Jun. 10, 2022 (CN) 202210657270.4

(51) Int. Cl. H05B 6/06; A24F 40/42; A24F 40/465; A24F 40/53; H05B 6/10

(52) U.S. Cl. CPC H05B 6/06; A24F 40/42; A24F 40/465; A24F 40/53; H05B 6/108

(57) ABSTRACT

A power supply assembly, an electronic atomization device, and a control method thereof are provided. The electronic atomization device includes: a liquid storage cavity for storing a liquid substrate; a power supply for supplying electricity; a magnetic field generating circuit electrically connected to the power supply for generating a varying magnetic field; a susceptor to be penetrated by the varying magnetic field to generate heat. to heat the liquid substrate to generate aerosols; and a controller electrically connected to the magnetic field generating circuit, for monitoring an electrical characteristic parameter of the magnetic field generating circuit and determine, based on the electrical characteristic parameter of the magnetic field generating circuit, whether adverse conditions exist in the susceptor.

### CROSS-REFERENCE TO RELATED APPLICATIONS

This application claims priority to Chinese Patent Application No. 202210657270.4, entitled “POWER SUPPLY ASSEMBLY, ELECTRONIC ATOMIZATION DEVICE, AND CONTROL METHOD THEREOF” and filed with the China National Intellectual Property Administration on Jun. 10, 2022, which is incorporated herein by reference in its entirety.

### TECHNICAL FIELD

This application relates to the field of electronic atomization technologies, and in particular, to a power supply assembly, an electronic atomization device, and a control method thereof.

### BACKGROUND

An electronic atomization device used as an example generally includes liquid, and the liquid is vaporized after being heated by a heating element, to generate inhalable aerosols. The liquid may include nicotine and/or fragrance and/or aerosol-generating substances (for example, glycerol).

In the foregoing heating device, an operating temperature of the heating element is generally obtained by monitoring a resistance change of the heating element, to determine whether the operating temperature of the heating element exceeds a preset range and further determine whether adverse conditions such as insufficient liquid supply exist in the electronic atomization device.

### SUMMARY

According to an aspect of this application, an electronic atomization device is provided, including:
a liquid storage cavity, configured to store a liquid substrate;
a power supply, configured to supply electricity;
a magnetic field generating circuit, electrically connected to the power supply, and configured to generate a varying magnetic field; and
a susceptor, configured to be penetrated by the varying magnetic field to generate heat, to heat the liquid substrate to generate aerosols; and
a controller, electrically connected to the magnetic field generating circuit, and configured to monitor an electrical characteristic parameter of the magnetic field generating circuit and determine, based on the electrical characteristic parameter of the magnetic field generating circuit, whether adverse conditions exist in the susceptor.

According to another aspect of this application, a power supply assembly is provided, configured to supply electricity to an atomizer of an electronic atomization device, where the atomizer includes a liquid storage cavity configured to store a liquid substrate and a susceptor configured to heat the liquid substrate to generate aerosols; and the power supply assembly includes:
a power supply, configured to supply electricity;
a magnetic field generating circuit, electrically connected to the power supply, and configured to generate a varying magnetic field; and
a controller, electrically connected to the magnetic field generating circuit, and configured to monitor an electrical characteristic parameter of the magnetic field generating circuit and determine, based on the electrical characteristic parameter of the magnetic field generating circuit, whether adverse conditions exist in the susceptor.

According to another aspect of this application, a control method of an electronic atomization device is provided, where the electronic atomization device includes:
a liquid storage cavity, configured to store a liquid substrate;
a power supply, configured to supply electricity;
a magnetic field generating circuit, electrically connected to the power supply, and configured to generate a varying magnetic field; and
a susceptor, configured to be penetrated by the varying magnetic field to generate heat, to heat the liquid substrate to generate aerosols; and
the method includes:
monitoring an electrical characteristic parameter of the magnetic field generating circuit and determining, based on the electrical characteristic parameter of the magnetic field generating circuit, whether adverse conditions exist in the susceptor.

According to the foregoing electronic atomization device, the electrical characteristic parameter of the magnetic field generating circuit is monitored, and whether adverse conditions exist in the susceptor is further determined based on the electrical characteristic parameter, so that the use experience of a user is improved.

### BRIEF DESCRIPTION OF THE DRAWINGS

One or more embodiments are exemplarily described with reference to the corresponding accompanying drawings, and the description does not constitute a limitation to the embodiments. Elements in the accompanying drawings that have same reference numerals are represented as similar elements, and unless otherwise particularly stated, the figures in the accompanying drawings are not drawn to scale.

FIG. 1 is a schematic diagram of an electronic atomization device according to an implementation of this application;

FIG. 2 is a block diagram of an electronic atomization device according to an implementation of this application;

FIG. 3 is a schematic diagram of a switch circuit and a resonance circuit according to an implementation of this application;

FIG. 4 is a schematic diagram of a detection circuit according to an implementation of this application;

FIG. 5 is a schematic diagram of a detection circuit according to another implementation of this application; and

FIG. 6 is a schematic diagram of a relationship between a temperature of a susceptor and a resonance voltage peak value of a magnetic field generating circuit according to an implementation of this application.

### DETAILED DESCRIPTION

To make the objectives, technical solutions, and advantages of embodiments of this application clearer, the following describes the technical solutions in the embodiments of this application clearly and completely with reference to the accompanying drawings in the embodiments of this application. Apparently, the described embodiments are merely some embodiments of this application rather than all of the embodiments. All other embodiments obtained by a person of ordinary skill in the art based on the embodiments of this application without creative efforts shall fall within the protection scope of this application.

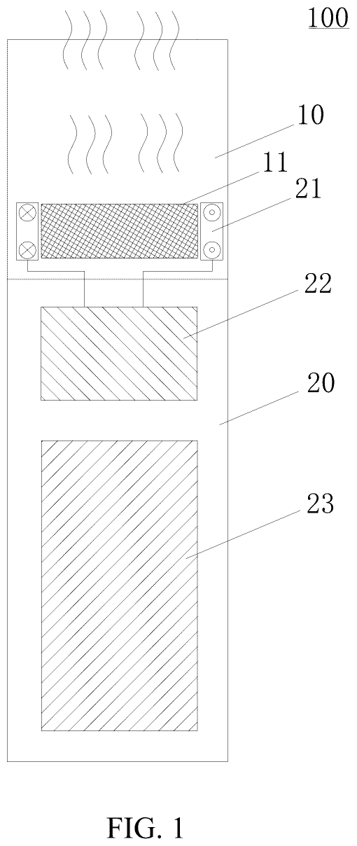

FIG. 1 is a schematic diagram of an electronic atomization device according to an implementation of this application.

As shown in FIG. 1, the electronic atomization device 100 includes an atomizer 10 and a power supply assembly 20. The atomizer 10 and the power supply assembly 20 are integrally formed.

The atomizer 10 includes a susceptor 11 and a liquid storage cavity (not shown). The liquid storage cavity is configured to store a liquid substrate that can be atomized; and the susceptor 11 is configured to be inductively coupled to an inductor 21 and to be penetrated by a varying magnetic field to generate heat, to heat the liquid substrate to generate inhalable aerosols.

Preferably, the liquid substrate includes a tobacco-contained material, and the tobacco-contained material includes volatile tobacco fragrance compounds released from the liquid substrate when being heated. Alternatively or in addition, the liquid substrate may include a non-tobacco material. The liquid substrate may include water, ethanol or another solvent, plant extracts, nicotine solution, and natural or artificial flavoring agents. Preferably, the liquid substrate further includes an aerosol forming agent. A suitable instance of the aerosol forming agent is glycerol and propylene.

Generally, the susceptor 11 may be made of at least one of the following materials: aluminum, iron, nickel, copper, bronze, cobalt, ordinary carbon steel, stainless steel, ferritic stainless steel, Martensitic stainless steel, or Austenitic stainless steel. In this example, a suitable material is selected, so that the susceptor 11 has a preset Curie temperature, and the preset Curie temperature is greater than an atomization or evaporating temperature of the liquid substrate. An example in which the atomization temperature of a liquid substrate is 250° C. is used, the preset Curie temperature may be 280° C., 290° C., 300° C., 310° C., 320° C., or the like. That is, a difference between the preset Curie temperature and the atomization temperature of the liquid substrate ranges from 30° C. to 70° C., preferably ranges from 30° C. to 60° C., and more preferably, ranges from 40° C. to 60° C. In a specific example, the difference between the preset Curie temperature and the atomization temperature of the liquid substrate is 50° C. The preset Curie temperature ranges from 250° C. to 450° C., preferably ranges from 250° C. to 400° C., and more preferably, ranges from 200° C. to 350° C.

The power supply assembly 20 includes an inductor 21, a circuit 22, and a power supply 23.

The inductor 21 generates a varying magnetic field under an alternating current, and the inductor 21 includes but is not limited to an induction coil.

The power supply 23 provides electricity for operating the electronic atomization device 100. The power supply 23 may be a rechargeable battery core or a disposable battery core.

The circuit 22 may control overall operations of the electronic atomization device 100. The circuit 22 not only controls operations of the power supply 23 and the inductor 21, but also controls operations of other elements in the electronic atomization device 100.

It may be understood that, in addition to the components shown in FIG. 1, the electronic atomization device 100 may further include other components, for example, a liquid transferring element. The liquid transferring unit may be cotton fiber, metal fiber, ceramic fiber, glass fiber, porous ceramics, or the like. The liquid transferring unit may be in a shape of a rod, a tube, or a lever, or may be in a shape of a plate, a sheet, or a concave block with a concave cavity on a surface, or may be in a shape of an arch with an arched structure.

Different from the example in FIG. 1, in other examples, the atomizer 10 and the power supply assembly 20 may be formed separately. For example, the atomizer 10 and the power supply assembly 20 may be detachably connected to each other in a snap-in connection manner or a magnetic connection manner.

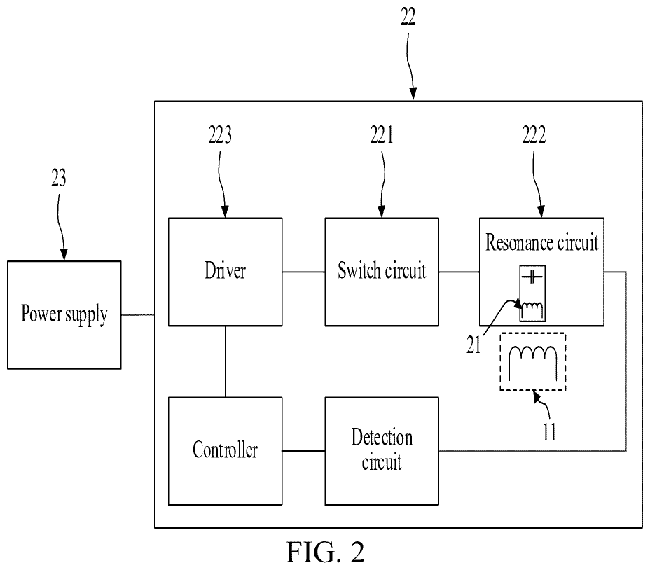

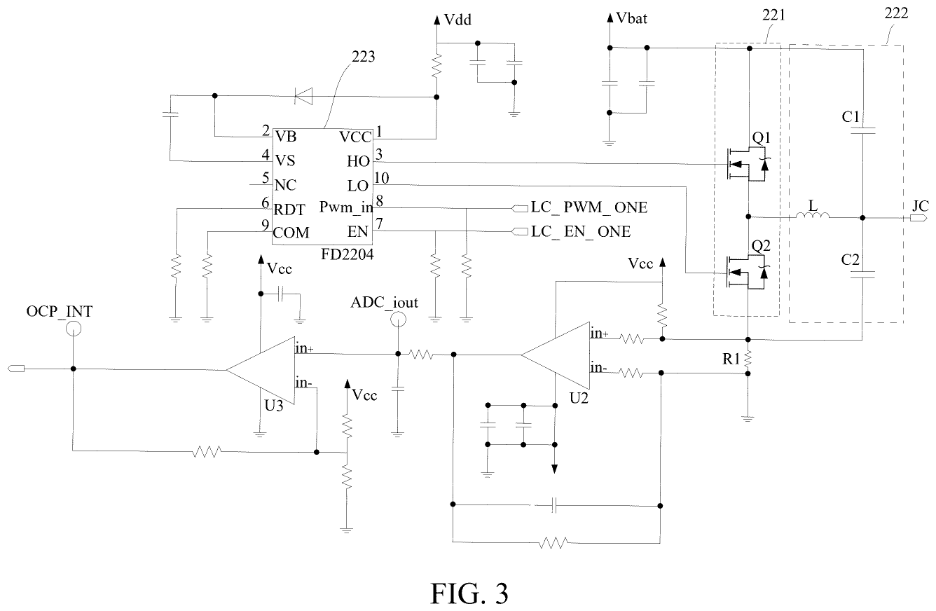

To accurately monitor an operating state of the susceptor 11, FIG. 2 and FIG. 3 show schematic diagrams of basic components of an embodiment of the circuit 22. The circuit 22 includes:
a magnetic field generating circuit, including a switch circuit 221 and a resonance circuit 222, where
the switch circuit 221 is a half-bridge circuit formed by transistor switches, and includes a switch tube Q1 and a switch tube Q2, which are configured to cause the resonance circuit 222 to resonate by switching turn-on and turn-off of the two switch tubes alternately; and
the resonance circuit 222 is formed by the inductor 21 (shown by L in the figure), a first capacitor C1, and a second capacitor C2, and the resonance circuit 222 is configured to form an alternating current flowing through the inductor L in a resonance process, to cause the inductor L to generate an alternating magnetic field, so as to induce the susceptor 11 to generate heat; and
a driver 223, configured to control the switch tube Q1 and the switch tube Q2 of the switch circuit 221 to be turned on and turned off alternately according to a control signal of a controller (not shown in the figure), where
the driver 223 is a switch tube driver of a commonly used FD2204 model, which is controlled by the controller in a PWM manner, and accordingly, a pulse width of PWM, a third I/O interface and a tenth I/O interface alternately send a high level/a low level to drive turn-on time of the switch tube Q1 and the switch tube Q2, so as to control the resonance circuit 222 to resonate. In other examples, the driver 223 is integrated in the controller or implemented by the controller, which is also feasible.

In terms of connection, a first end of the first capacitor C1 is connected to Vbat (Vbat may be the power supply 23 or a power supply obtained after the power supply 23 is regulated), and a second end of the first capacitor is connected to a first end of the second capacitor C2; and a second end of the second capacitor C2 is grounded through a resistor R1.

A first end of the switch tube Q1 of the switch circuit 221 is connected to Vbat, a second end of the switch tube Q1 is connected to a first end of the switch tube Q2, and a second end of the switch tube Q2 is grounded through the resistor R1. Certainly, control ends of the switch tube Q1 and the switch tube Q2 are both connected to the driver 223, and are turned on and turned off under driving of the driver 223. The switch tube Q1 and the switch tube Q2 include, but are not limited to IGBT transistors, MOS transistors, or the like.

A first end of the inductor L is connected to the second end of the switch tube Q1, and a second end of the inductor L is connected to the second end of the first capacitor C1. In addition, in terms of hardware selection of the resonance circuit 222, withstand voltages of the first capacitor C1 and the second capacitor C2 are far greater than an output voltage of the power supply 23. For example, in a common implementation, the output voltage of the used power supply 23 is approximately 4 V, and the withstand voltages of the used first capacitor C1 and second capacitor C2 range from 30 V to 80 V.

In a switching state of the switch tube Q1 and the switch tube Q2, in the resonance circuit 222 of the foregoing structure, connection states between the first capacitor C1 and the inductor L and between the second capacitor C2 and the inductor L are varying. When the switch tube Q1 is turned on and the switch tube Q2 is turned off, the first capacitor C1 and the inductor L jointly form a closed LC series circuit, and the second capacitor C2 and the inductor L form an LC series circuit with two ends respectively connected to Vbat and the ground (the circuit starts from Vbat, passes through the inductor L and the second capacitor C2 sequentially, and ends at a ground end). When the switch tube Q1 is turned off and the switch tube Q2 is turned on, formed circuits are opposite to the foregoing state, the first capacitor C1 and the inductor L form an LC series circuit with two ends respectively connected to Vbat and the ground, and the second capacitor C2 and the inductor L jointly form a closed LC series circuit. In different states, the first capacitor C1 and the second capacitor C2 can both form respective LC series circuits with the inductor L.

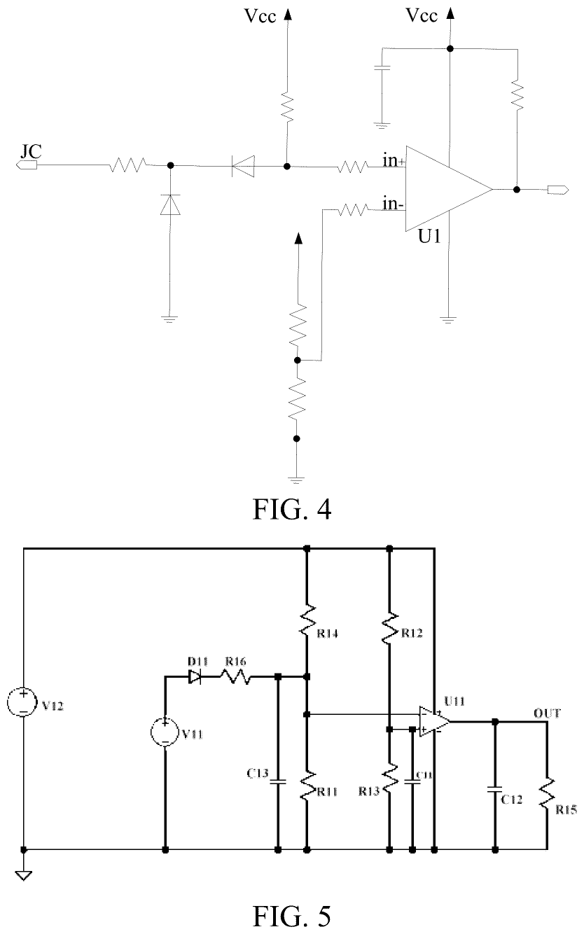

To accurately detect details such as a resonance process and a periodicity of the resonance circuit 222, as shown in FIG. 4, a detection circuit is further included during implementation and is configured to synchronously detect varying physical parameters such as a current, a voltage, or the periodicity in the resonance process of the resonance circuit 222. Specifically, in the embodiment shown in FIG. 4, the synchronous detection circuit includes an operational amplifier U1, and a signal input end detected by the detection circuit is connected to the second end of the inductor L (as shown by a JC connection end in the figure). In an optional implementation, a reference signal end of the operational amplifier U1 is directly set to 0, so that the operational amplifier U1 becomes a zero-crossing comparator configured to detect a moment at which a resonance current of the resonance circuit 222 is 0, and the controller obtains the varying physical parameters such as the current, the voltage, or the periodicity of the resonance circuit 222 according to a detection result in combination with a zero-crossing time point. It should be noted that, in some embodiments, the detection circuit is configured to sample a value of a current flowing through the resonance circuit 222. A high-end current detection method may be used, for example, a sampling resistor is arranged between Vbat and the resonance circuit 222; or a low-end current detection method may be used, for example, a sampling resistor is arranged between the resonance circuit 222 and the ground end.

As shown in FIG. 5, in another implementation, a resonance voltage (shown by V11 in the figure) of the resonance circuit 222 may pass through an RC integrator circuit formed by D11, R16, and C13, and finally be inputted to a negative input end of the comparator U11 after being divided by a voltage dividing circuit formed by R11 and R14. When a voltage at the negative input end of the comparator U11 is higher than a voltage at a positive input end, the comparator U11 (an OUT end in the figure) outputs a low level; and when the voltage at the negative input end is lower than the voltage at the positive input end, the comparator U1 outputs a high level. The controller may control the electricity supplied by the power supply 23 according to a level outputted by the comparator U11. The comparator U11 may be integrated in the controller, and it is also feasible that the comparator U11 is independent of the controller.

In an example, the susceptor 11 is made of a material having a preset Curie temperature, and when a temperature of the susceptor 11 gradually reaches the Curie temperature, magnetism of the material gradually disappears. In this case, a magnetic coupling coefficient between the inductor L and the susceptor 11 is gradually decreased, and a Q value (quality factor) of the magnetic field generating circuit is gradually increased. In this case, an electrical characteristic parameter, for example, a resonance voltage value or a current value of the magnetic field generating circuit changes correspondingly. When the temperature of the susceptor 11 is risen to or close to the Curie temperature, the resonance voltage value or the current value in the resonance circuit 222 suddenly changes and is increased to an extremely high value. In another example, when the susceptor in the atomizer is not coupled to the resonance circuit, that is, when the power supply assembly is in a no-load state, the resonance voltage value or the current value is apparently higher than that when the power supply assembly is in a load state.

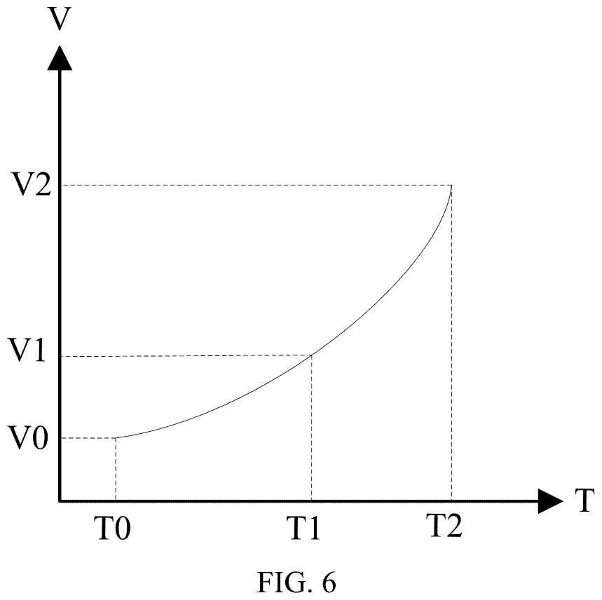

Therefore, the controller may determine, according to the electrical characteristic parameter of the magnetic field generating circuit, whether adverse conditions exist in the susceptor 11, to further adjust the electricity supplied by the power supply 23. For example, the controller shuts off or limits the electricity supplied by the power supply 23 to the magnetic field generating circuit when the susceptor 11 is in the adverse conditions. FIG. 6 is used as an example, in FIG. 6, a horizontal coordinate represents the temperature of the susceptor 11, and a vertical ordinate represents a resonance voltage peak value of the magnetic field generating circuit. When the temperature of the susceptor 11 is T0, because the temperature has not reached the Curie temperature T2, the magnetic coupling coefficient between the inductor L and the susceptor 11 is large, the Q value of the magnetic field generating circuit is small, and the resonance voltage peak value V0 of the magnetic field generating circuit is also small. When the temperature of the susceptor 11 is the Curie temperature T2, the magnetic coupling coefficient between the inductor L and the susceptor 11 is small, the Q value of the magnetic field generating circuit is large, and the resonance voltage peak value V2 of the magnetic field generating circuit is also large. Based on a relationship between the resonance voltage peak value and the temperature, the controller may monitor the resonance voltage peak value of the magnetic field generating circuit and determine, according to the resonance voltage peak value of the magnetic field generating circuit, whether adverse conditions exist in the susceptor 11. For example, when it is monitored that the resonance voltage peak value V1 of the magnetic field generating circuit reaches or exceeds V2, or a deviation value between V1 and V2 of the resonance voltage peak value is less than a preset deviation threshold, it may be determined that the adverse conditions exist in the susceptor 11. In this case, the controller may shut off or limit the electricity supplied by the power supply 23 to the magnetic field generating circuit.

In some other embodiments, for a susceptor made of materials of a type, during inhalation of the electronic atomization device, the susceptor is configured to heat the liquid substrate and vaporize the liquid substrate into aerosols. In an early stage of the inhalation, the temperature of the susceptor is gradually risen to the atomization temperature of the liquid substrate, and the resonance voltage or the current value in the resonance circuit coupled to the susceptor is gradually decreased in this process. In a subsequent aerosol generation process, in a case that supply of the liquid substrate is sufficient and the susceptor is fully soaked, the temperature of the susceptor does not change sharply, so that the resonance voltage or the current value in the resonance circuit is kept in a stable interval. In a case that the liquid substrate is lacked and a storage amount is small, that is, the susceptor is not fully soaked, the temperature of the susceptor is risen sharply but does not reach the Curie temperature. In this case, the resonance voltage or the current value in the resonance circuit is decreased sharply accordingly, and the controller may monitor the decrease in the electrical characteristic parameter such as the resonance voltage to determine a lack of liquid around the susceptor. In a case that the liquid substrate is completely consumed, the temperature of the susceptor is risen to the Curie temperature. In this case, the magnetism of the susceptor almost disappears, the resonance voltage or the current value in the resonance circuit changes suddenly and is increased sharply, and the controller may monitor the sharp increase in the electrical characteristic parameter such as the resonance voltage to determine complete consumption of liquid around the susceptor.

In another example, due to differences caused by factors such as a material, a size, or a volume of the susceptor 11, magnetic coupling coefficient between different susceptors 11 and the inductor L are different, Q values of the magnetic field generating circuit are also different, and corresponding resonance voltage values and current values are also different. Based on this, the controller may monitor the electrical characteristic parameter of the magnetic field generating circuit, to determine whether adverse conditions exist in the susceptor 11. For example, the atomizer 10 coupled to the power supply assembly 20 is counterfeited, unqualified, or damaged.

In another example, before and after the atomizer 10 is connected to the power supply assembly 20, Q values of the magnetic field generating circuit are also different, and corresponding resonance voltage values and current values are also different. Based on this, the controller may monitor the electrical characteristic parameter of the magnetic field generating circuit, to determine whether adverse conditions exist in the susceptor 11. For example, the atomizer 10 is connected to the power supply assembly 20, or the atomizer 10 is removed from the power supply assembly 20.

In a specific implementation, the adverse conditions of the susceptor 11 include a case that the liquid substrate transferred or provided to the susceptor 11 is insufficient or depleted. Generally, when constant power or electricity is provided to the resonance circuit and the susceptor 11, a fewer liquid substrate transferred or provided to the susceptor 11 indicates a higher temperature of the susceptor 11.

In still another implementation, the adverse conditions of the susceptor 11 include that an operating parameter such as a temperature or a voltage of the susceptor 11 exceeds a normal expected value, that is, an operating state of the susceptor 11 exceeds an expected normal range, which is likely to bring a safety risk.

In still another variant implementation, the adverse conditions of the susceptor 11 include that the atomizer 10 is not coupled (connected) to the power supply assembly 20 or another foreign object is coupled to the power supply assembly 20. Similar to the foregoing, when the atomizer 10 is not coupled to the power supply assembly 20, the magnetic coupling coefficient between the inductor L and the susceptor 11 is small; and when the atomizer 10 is coupled to the power supply assembly 20, the magnetic coupling coefficient between the inductor L and the susceptor 11 is increased, and a corresponding Q (quality factor) value of the magnetic field generating circuit is decreased. If another foreign object is coupled to the power supply assembly 20, if the foreign object is magnetically coupled to the susceptor 11, the susceptor does not have the same operating parameter or characteristic (for example, a voltage or a current) as a standard susceptor 11 under given electricity; and if the foreign object is not magnetically coupled to the susceptor 11, there is no change between magnetic coupling coefficients before and after coupling.

In still another variant implementation, the adverse conditions of the susceptor 11 include that the atomizer 10 coupled to the power supply assembly 20 is counterfeited, unqualified, or damaged. For a counterfeited, unqualified, or damaged atomizer 10, the susceptor coupled to the atomizer does not have the same operating parameter or characteristic (for example, a voltage or a current) as a standard susceptor 11 under given electricity.

In another implementation, the adverse conditions include that the liquid substrate provided by the atomizer 10 to the susceptor 11 is undesirable. Specifically, the undesirable liquid substrate and a desired liquid substrate may have different compositions, and consequently have different viscosities, heat capacities, or boiling points, so that the liquid substrate requires higher or lower temperature, power, or electricity than expected during heating and atomization.

In the embodiment shown in FIG. 3, the electrical characteristic parameter of the magnetic field generating circuit includes the resonance voltage value of the resonance circuit 222 such as a resonance voltage peak value; or
a resonance voltage value detected based on the synchronous detection circuit.

In an embodiment, the controller is further configured to determine whether adverse conditions exist in the susceptor 11 according to a comparison result of the resonance voltage value and a preset threshold. An example in which the liquid substrate transferred or provided to the susceptor 11 is insufficient or depleted is used, the resonance voltage value is compared with the preset threshold, and if the resonance voltage value is greater than the preset threshold, it may be determined that the susceptor 11 is in an over-temperature state and dry burning occurs.

In an embodiment, the controller is further configured to determine whether adverse conditions exist in the susceptor 11 according to a change amount or a change rate of the resonance voltage value of the magnetic field generating circuit within a predetermined time. For example, in an inhalation process, whether adverse conditions exist in an operating situation of the susceptor 11 is determined by calculating whether the change amount ΔV or the change rate (ΔV/t1) of the resonance voltage value within a predetermined time t1 exceeds a preset threshold range, where the predetermined time may be an experience value or an experimental value, which is not limited herein. The change amount ΔV or the change rate (ΔV/t1) of the resonance voltage value may be increased or decreased relative to an initial voltage value.

In an embodiment, the controller is configured to determine whether adverse conditions exist in the susceptor 11 according to a ratio (ΔV/V0) of a change amount ΔV of the resonance voltage value of the magnetic field generating circuit relative to an initial value to the initial value V0. During specific implementation, a threshold satisfying normal operation may be selected according to the ratio ΔV/V0, and when the ratio ΔV/V0 is greater than a threshold, it may be determined that the adverse conditions exist.

In an embodiment, the controller is further configured to determine whether adverse conditions exist in the susceptor 11 according to a comparison result of a duration for the resonance voltage value of the magnetic field generating circuit to reach a preset threshold from an initial value and a preset time threshold. For example, under given electricity, a magnetic field generating circuit containing a standard susceptor 11 can reach the preset threshold within an expected time period, but a magnetic field generating circuit containing a counterfeited, unqualified, or damaged atomizer 10 can only reach the preset threshold outside the expected time period. Therefore, it may be determined that adverse conditions exist in the susceptor 11. The initial value is not limited, which may be zero or may be a value between zero and a resonance voltage peak value. In some optional implementations, the expected time period ranges, for example, from 50 ms to 200 ms; or may range from 80 ms to 200 ms. Alternatively, in some preferred implementations, the expected time period ranges from 50 ms to 150 ms.

In an embodiment, the controller is further configured to stop the electricity supplied by the power supply 23 when a number of times the adverse conditions exist in the susceptor 11 is greater than a preset threshold.

It should be noted that, the foregoing examples are only described by using an LCC series resonance circuit as an example. In other examples, an LC series resonance circuit (including but not limited to half-bridge series resonance and full-bridge series resonance), an LC parallel resonance circuit, or the like may also be used for description.

It should be noted that, the foregoing examples are only described by using the resonance voltage of the magnetic field generating circuit as an example. It is conceivable that the electrical characteristic parameter of the magnetic field generating circuit includes at least one of the following: a current value, a quality factor Q, a resonance frequency, an inductance value, and another electrical characteristic parameter derived from the foregoing parameters. These electrical characteristic parameters may be obtained through direct measurement or calculation.

It should be finally noted that, the foregoing embodiments are only used for describing the technical solutions of this application rather than limiting this application. Under the ideas of this application, the technical features in the foregoing embodiments or different embodiments may also be combined, the steps may be performed in any order, and many other changes of different aspects of this application also exist as described above, and these changes are not provided in detail for simplicity. Although this application is described in detail with reference to the foregoing embodiments, a person of ordinary skill in the art should understand that modifications may be still made to the technical solutions described in the foregoing embodiments or equivalent replacements may be made to some technical features thereof, and such modifications or replacements do not make the essence of corresponding technical solutions depart from the scope of the technical solutions of the embodiments of this application.

What is claimed is:

1. An electronic atomization device comprising:
a liquid storage cavity configured to store a liquid substrate;
a power supply configured to supply electricity;
a magnetic field generating circuit, electrically connected to the power supply and configured to generate a varying magnetic field;
a susceptor configured to be penetrated by the varying magnetic field to generate heat, to heat the liquid substrate to generate aerosols; and
a controller, electrically connected to the magnetic field generating circuit, and configured to monitor an electrical characteristic parameter of the magnetic field generating circuit and determine, based on the electrical characteristic parameter of the magnetic field generating circuit, whether adverse conditions exist in the susceptor.

2. The electronic atomization device according to claim 1, wherein a material of the susceptor has a preset Curie temperature, and the preset Curie temperature is greater than an evaporating temperature of the liquid substrate.

3. The electronic atomization device according to claim 2, wherein a difference between the preset Curie temperature and the evaporating temperature of the liquid substrate ranges from 30° C. to 70° C.

4. The electronic atomization device according to claim 1, wherein the adverse conditions of the susceptor comprise at least one of the following:
the liquid substrate transferred or provided to the susceptor is insufficient, depleted, or undesirable;
an operating parameter of the susceptor exceeds a normal expected value; or
the electronic atomization device comprises a power supply assembly and an atomizer removably connected to the power supply assembly, and the atomizer connected to the power supply assembly is counterfeited, unqualified, or damaged, or the atomizer is not connected to the power supply assembly, or another foreign object is connected to the power supply assembly.

5. The electronic atomization device according to claim 1, wherein the electrical characteristic parameter of the magnetic field generating circuit comprises at least one of the following:
a current value, a resonance voltage value, a quality factor Q, a resonance frequency, an inductance value, or another electrical characteristic parameter derived from the foregoing parameters.

6. The electronic atomization device according to claim 1, wherein the controller is further configured to determine whether adverse conditions exist in the susceptor according to a comparison result of the electrical characteristic parameter of the magnetic field generating circuit and a preset threshold.

7. The electronic atomization device according to claim 1, wherein the controller is further configured to determine whether adverse conditions exist in the susceptor according to a change amount or a change rate of the electrical characteristic parameter of the magnetic field generating circuit within a predetermined time.

8. The electronic atomization device according to claim 1, wherein the controller is configured to determine whether adverse conditions exist in the susceptor according to a ratio of a change amount of the electrical characteristic parameter of the magnetic field generating circuit relative to an initial value to the initial value.

9. The electronic atomization device according to claim 1, wherein the controller is further configured to determine whether adverse conditions exist in the susceptor according to a comparison result of a duration for the electrical characteristic parameter of the magnetic field generating circuit to reach a preset threshold from an initial value and a preset time threshold.

10. The electronic atomization device according to claim 1, wherein the controller is further configured to shut off or limit the electricity supplied by the power supply to the magnetic field generating circuit when the susceptor is in the adverse conditions.

11. The electronic atomization device according to claim 10, wherein the controller is further configured to stop the electricity supplied by the power supply to the magnetic field generating circuit when a number of times the adverse conditions exist in the susceptor is greater than a preset threshold.

12. The electronic atomization device according to claim 1, wherein:
the magnetic field generating circuit comprises a switch circuit and a resonance circuit; the resonance circuit comprises an inductor and a capacitor; and
the switch circuit is configured to be turned on and turned off alternately under driving of a pulse signal, to cause an alternating current to flow through the inductor in the resonance circuit and generate the varying magnetic field.

13. The electronic atomization device according to claim 1, wherein:
the electronic atomization device comprises a power supply assembly and an atomizer removably connected to the power supply assembly; and
the power supply, the magnetic field generating circuit, and the controller are all arranged in the power supply assembly; and the susceptor is arranged in the atomizer and the atomizer comprises the liquid substrate.

14. A power supply assembly, configured to supply electricity to an atomizer of an electronic atomization device, wherein the atomizer comprises a liquid storage cavity configured to store a liquid substrate and a susceptor configured to heat the liquid substrate to generate aerosols; and the power supply assembly comprises:
a power supply, configured to supply electricity;
a magnetic field generating circuit, electrically connected to the power supply, and configured to generate a varying magnetic field; and
a controller, electrically connected to the magnetic field generating circuit, and configured to monitor an electrical characteristic parameter of the magnetic field generating circuit and determine, based on the electrical characteristic parameter of the magnetic field generating circuit, whether adverse conditions exist in the susceptor.

15. A control method of an electronic atomization device, wherein the electronic atomization device comprises:
a liquid storage cavity, configured to store a liquid substrate;
a power supply, configured to supply electricity;
a magnetic field generating circuit, electrically connected to the power supply, and configured to generate a varying magnetic field; and
a susceptor, configured to be penetrated by the varying magnetic field to generate heat, to heat the liquid substrate to generate aerosols;
wherein the method comprises:
monitoring an electrical characteristic parameter of the magnetic field generating circuit and determining, based on the electrical characteristic parameter of the magnetic field generating circuit, whether adverse conditions exist in the susceptor.
